(19) United States
(12) Patent Application Publication
(10) Pub. No.: US 2008/0239237 A1
(43) Pub. Date: Oct. 2, 2008

(54) MOLDS WITH THERMOPLASTIC ELASTOMERS FOR PRODUCING OPHTHALMIC LENSES

(76) Inventors: Scott F. Ansell, Jacksonville, FL (US); Changhong Yin, St. Augustine, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/694,130

(22) Filed: Mar. 30, 2007

(51) Int. Cl. G02C 7/04

(52) U.S. Cl. 351/160 R; 264/1.36; 425/174.4

(57) ABSTRACT

This invention discloses improved mold parts fashioned from a thermoplastic resin compounded with a thermoplastic elastomers. The mold parts can be used in manufacturing processes, such as, for example: continuous, in-line or batched processes to obtain a high degree of precision and accuracy, such as those necessary in the manufacture of ophthalmic lens mold applications. In addition, the present invention includes ophthalmic lenses created using the improved mold parts.

### FIELD OF USE

This invention describes molds with thermoplastic elastomers that are useful in the production of contact lenses and methods for their use.

### BACKGROUND

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses based upon hydrogels.

Hydrogel contact lenses are popular and often more comfortable to wear than contact lenses made of hard materials. Malleable soft contact lenses made from hydrogels can be manufactured by forming a lens in a multi-part mold where the combined parts form a topography consistent with the desired final lens.

Ophthalmic lenses are often made by cast molding, in which a monomer material is deposited in a cavity defined between optical surfaces of opposing mold parts. Multi-part molds used to fashion hydrogels into a useful article, such as an ophthalmic lens, can include for example, a first mold part with a convex portion that corresponds with a back curve of an ophthalmic lens and a second mold part with a concave portion that corresponds with a front curve of the ophthalmic lens. To prepare a lens using such mold parts, an uncured hydrogel lens formulation is placed between a front curve mold part and a back curve mold part. The mold parts are brought together to shape the lens formulation according to desired lens parameters. Traditionally, a lens edge was formed about the perimeter of the formed lens by compression of an edge formed into the mold parts which penetrates the lens formulation and incises it into a lens portion and an excess ring portion. The lens formulation was subsequently cured, for example by exposure to heat and light, thereby forming a lens.

Following cure, mold portions are separated and the lens remains adhered to one of the mold portions. The lens and the excess polymer ring must be separated and the excess polymer ring discarded. During mold separation lens damage may occur. Damage can include, for example: edge chips and tears; holes; lens delamination or pulls; lenses adhering to a wrong mold part, optical distortion; and surface marks.

It is desirable therefore to have mold materials which minimize the physical stresses placed on contact lenses during demold and ultimately reduce lens defects resulting from such stresses.

### SUMMARY

Accordingly, the present invention includes improved molds and processes useful in the creation of an ophthalmic lens. According to the present invention, a lens forming mixture is cured in a cavity of a desired shape formed by two or more mold parts. At least one of the mold parts is molded from a material including a thermoplastic elastomer. The cavity can be in the shape and size of an ophthalmic lens and at least one of the first mold part and the second mold part can include a lens-forming surface.

Embodiments can include at least one of the mold parts being transparent to polymerization initiating radiation such that a polymerizable lens forming mixture can be deposited in the cavity and the mold part and polymerizable composition can be exposed to polymerization initiating radiation.

The present invention includes molds for ophthalmic lens manufacture and methods of molding an ophthalmic lens, wherein a lens forming mixture is cured in a cavity of a desired shape formed by two or more mold parts with at least one of the mold parts comprising a compound of a thermal plastic resin compounded and a thermal plastic elastomer.

In some embodiments, a first mold part includes a concave surface, a second mold part includes a convex surface, and at least the second mold part includes a thermal plastic resin compounded with a thermal plastic elastomer.

In another aspect, in some embodiments, at least one mold part molded from a thermal plastic resin compounded with a thermal plastic elastomer includes a surface energy of less than 30 mN/m or even less than 26 mN/m, as determined with one or ore of: the Owens-Wendt method and the Zisman method.

Still another aspect includes a mold part molded from a thermal plastic resin compounded with a thermal plastic elastomer with a contact angle of deionized water greater than about 99°.

The thermal plastic elastomer can include styrene block copolymer, such as one or more of the group comprising: styrene ethylene butylene; styrene ethylene propylene; and a styrene-ethylene-ethylene-propylene-styrene block copolymer. A mold material can include between about 5% weight and 75% weight thermal plastic elastomer, and in some preferred embodiments, between about 10% weight and 50% weight thermal plastic elastomer.

In some embodiments, a thermoplastic resin can include a polyolefin having a melt flow rate of less than 21 g/10 minutes and the thermal plastic resin compounded with a thermal plastic elastomer has a melt flow rate greater than about 21 g/10 minutes.

Embodiments can also include methods of producing an ophthalmic lens by dispensing an uncured lens formulation onto a surface of a mold part formed from a resin comprising a thermoplastic elastomer; and curing said lens formulation under conditions suitable to the particular lens formulation. The lens can include, for example, a silicone hydrogel formulation or a hydrogel formulation. Specific examples can include a lens formed from: acquafilcon A, balafilcon A, and lotrafilcon A, etafilcon A, genfilcon A, lenefilcon A, polymacon and galyfilcon A, and senofilcon A.

### DESCRIPTION OF THE DRAWINGS

FIG. 1 illustrates a mold assembly according to some embodiments of the present invention.

FIG. 2 illustrates a flow chart of exemplary steps that can be executed while implementing some embodiments of the present to create a mold part.

FIG. 3 illustrates a flow chart of exemplary steps that can be executed while implementing some embodiments of the present to create an ophthalmic lens.

FIG. 4 illustrates exemplary data indicating surface energy qualities of molds fashioned from a thermoplastic elastomer.

FIG. 5 illustrates exemplary data indicating contact angle qualities of molds fashioned from a thermoplastic elastomer.

### DETAILED DESCRIPTION OF THE INVENTION

The present invention includes molds and methods for making an ophthalmic lens. According to the present invention, at least one part of a multi-part mold that can be used in the manufacture ophthalmic lenses, is injection molded, or otherwise fashioned, from a thermal plastic resin (hereinafter referred to as “TPR”) compounded with a thermal plastic elastomer (hereinafter referred to as “TPE”). One exemplary TPE, as used in this specification, specifically includes styrene-ethylene-butadiene-styrene (hereinafter referred to as “SEBS”), a special hydrogenated styrenic block copolymer. Still other embodiments can include special olefin and block copolymers.

In some embodiments of the present invention, ophthalmic lens molds comprising TPR and TPE compounds can result in a mold surface energy of an uncoated ophthalmic lens mold of about 25 mN/m or less. Methods of the present invention therefore include fashioning an ophthalmic lens from a mold with one or more mold part having an uncoated surface energy of about 25 mN/m or less.

In another aspect, ophthalmic lens molds comprising TPR and TPE compounds can result in a contact angle of deionized water of an uncoated ophthalmic lens mold of about 97.5° or more and methods of the present invention can include fashioning an ophthalmic lens from a mold with one or more mold part having an uncoated contact angle of deionized water of about 97.5° or more.

Additional embodiments include increasing the thermal linear expansion coefficient of a thermal plastic used to fashion one or both ophthalmic lens mold parts with an amount of TPE effective to raise the thermal linear expansion coefficient 1% or more.

Mold parts to form an ophthalmic lens are injection molded from thermoplastic elastomer resin. Injection molding apparatus will typically include precision tooling that has been machined from a metal, such as, for example, brass, stainless steel or nickel or some combination thereof. Typically, tooling is fashioned in a desired shape and machined or polished to achieve precision surface quality. The precision surface in turn increases the quality of a mold part injection molded therefrom.

In some preferred embodiments, mold parts are fashioned from a blend of a thermoplastic elastomer with a thermoplastic polyolefin to produce single use cast molds with improved characteristics conducive to the manufacture of ophthalmic lenses. Advantages of utilizing molds comprising a blend of a thermoplastic elastomer and a thermoplastic polyolefin material include a diminished number of lens defects, such as holes, chips and tears resulting from demold; and also improved release from a mold part in which it is formed. Use of one or both mold parts fashioned from a mold material which includes TPE exposes a lens to much less aggression during lens manufacture.

### Lenses

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision.

As used herein, the term “lens forming mixture” refers to a mixture of materials that can react, or be cured, to form an ophthalmic lens. Such a mixture can include polymerizable components (monomers), additives such as UV blockers and tints, photoinitiators or catalysts, and other additives one might desire in an ophthalmic lens such as a contact or intraocular lens.

In some embodiments, a preferred lens type can include a lens that is made from silicone elastomers or hydrogels, such as, for example, silicone hydrogels, fluorohydrogels, including those comprising silicone/hydrophilic macromers, silicone based monomers, initiators and additives. By way of non-limiting example, some preferred lens types can also include etafilcon A, genifilcon A, lenefilcon A, polymacon, acquafilcon A, balafilcon A, lotrafilcon A, galyfilcon A, senofilcon A, silicone hydrogels.

### Molds

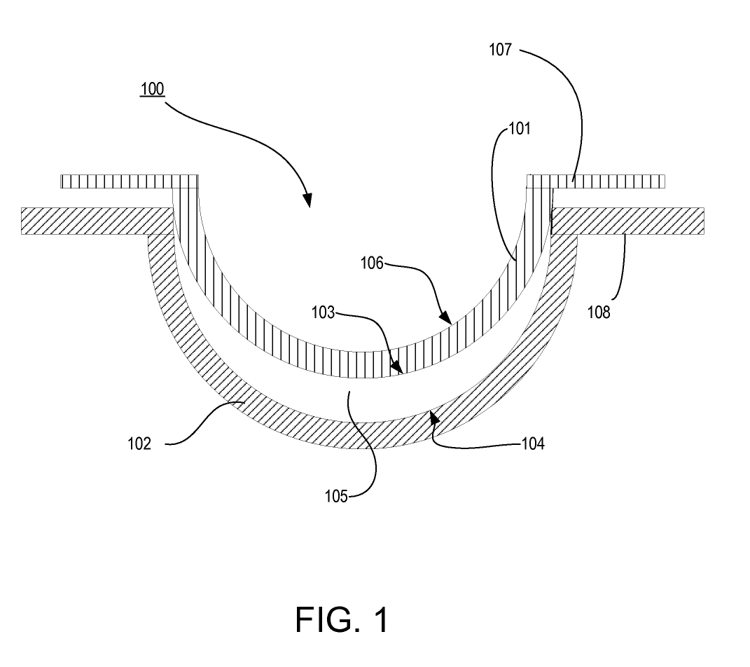

Referring now to FIG. 1, a diagram of an exemplary mold for an ophthalmic lens is illustrated. As used herein, the terms “mold” and “mold assembly” refer to a form 100 having a cavity 105 into which a lens forming mixture can be dispensed such that upon reaction or cure of the lens forming mixture (not illustrated), an ophthalmic lens of a desired shape is produced. The molds and mold assemblies 100 of this invention are made up of more than one “mold parts” or “mold pieces” 101-102. The mold parts 101-102 can be brought together such that a cavity 105 is formed between the mold parts 101-102 in which a lens can be formed. This combination of mold parts 101-102 is preferably temporary. Upon formation of the lens, the mold parts 101-102 can again be separated for removal of the lens.

At least one mold part 101-102 has at least a portion of its surface 103-104 in contact with the lens forming mixture such that upon reaction or cure of the lens forming mixture that surface 103-104 provides a desired shape and form to the portion of the lens with which it is in contact. The same is true of at least one other mold part 101-102.

Thus, for example, in a preferred embodiment a mold assembly 100 is formed from two parts 101-102, a female concave piece (front piece) 102 and a male convex piece (back piece) 101 with a cavity formed between them. The portion of the concave surface 104 which makes contact with lens forming mixture has the curvature of the front curve of an ophthalmic lens to be produced in the mold assembly 100 and is sufficiently smooth and formed such that the surface of a ophthalmic lens formed by polymerization of the lens forming mixture which is in contact with the concave surface 104 is optically acceptable.

In some embodiments, the front mold piece 102 can also have an annular flange integral with and surrounding circular circumferential edge 108 and extends from it in a plane normal to the axis and extending from the flange (not shown).

The back mold piece 101 has a central curved section with a concave surface 106, convex surface 103 and circular circumferential edge 107, wherein the portion of the convex surface 103 in contact with the lens forming mixture has the curvature of the back curve of a ophthalmic lens to be produced in the mold assembly 100 and is sufficiently smooth and formed such that the surface of a ophthalmic lens formed by reaction or cure of the lens forming mixture in contact with the back surface 103 is optically acceptable. Accordingly, the inner concave surface 104 of the front mold half 102 defines the outer surface of the ophthalmic lens, while the outer convex surface 103 of the base mold half 101 defines the inner surface of the ophthalmic lens.

In some preferred embodiments, molds 100 can include two mold parts 101-102 as described above, wherein one or both of the front curve part 102 and the back curve part 101 of the mold 100 is made of a material including a TPE. Preferred embodiments include a mold material including a TPE compounded with a thermoplastic.

TPEs useful as ophthalmic lens material according to the present invention can include, by way of non-limiting example, one or more of the Styrene Block Copolymers, such as, SEBS, SEP, SEPS, SEEPS, SBS, SIS, which can be defined as follows:

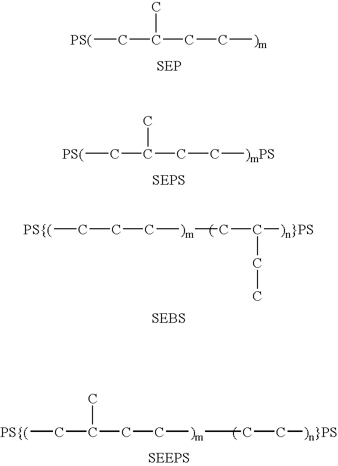

Specific examples may therefore include styrene block copolymers from Asahi KAESI (TUFTEC™), SEPTON Company of America (SEPTON™), and Kraton Polymers (Kraton®).

By way of additional non-limiting example, olefin based TPE can include Vistamaxx™ from ExxonMobil and TAFMER® Alpha-Olefin Copolymer from Mitsui Chemicals America, “INFUSE™ (Olefin Block Copolymer) from Dow Chemical is also considered as olefin-based elastomer

Thermoplastics that can be compounded with the TPE can include, for example, one or more of: polypropylene, polystyrene and alicyclic polymers.

In some embodiments the thermoplastic resin can include an alicyclic polymer which refers to compounds having at least one saturated carbocyclic ring therein. The saturated carbocyclic rings may be substituted with one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents are selected from one or more members of the group consisting of halogen, hydroxyl, C₁₋₁₀alkoxycarbonyl, C₁₋₁₀alkoxy, cyano, amido, imido, and silyl. Examples of alicyclic polymers include but are not limited to polymerizable cyclobutanes, cyclopentanes, cyclohexanes, cycloheptanes, cyclooctanes, biscyclobutanes, biscyclopentanes, biscyclohexanes, biscycloheptanes, biscyclooctanes, and norbornanes. It is preferred that the at least two alicyclic polymers be polymerized by ring opening metathesis followed by hydrogenation. Since co-polymers are costly, it is preferable that the molds made from these co-polymers may be used several times to prepare lenses instead of once which is typical. For the preferred molds of the invention, they may be used more than once to produce lenses.

More particularly, examples of alicyclic polymer containing saturated carbocyclic rings include but are not limited to the following structures

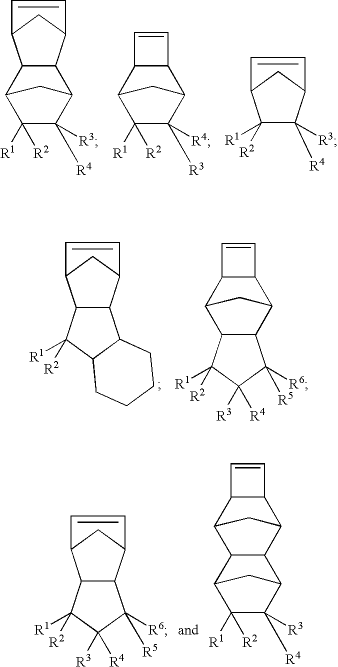

wherein R¹^{_{—}}⁶ are independently selected from one or more members of the group consisting of hydrogen, C₁₋₁₀alkyl, halogen, hydroxyl, C₁₋₁₀alkoxycarbonyl, C₁₋₁₀alkoxy, cyano, amido, imido, silyl, and substituted C₁₋₁₀alkyl where the substituents selected from one or more members of the group consisting of halogen, hydroxyl, C₁₋₁₀alkoxycarbonyl, C₁₋₁₀alkoxy, cyano, amido, imido and silyl. Further two or more of R¹⁻⁶ may be taken together to form an unsaturated bond, a carbocyclic ring, a carbocyclic ring containing one or more unsaturated bonds, or an aromatic ring. The preferred R¹⁻⁶ is selected from the group consisting of C₁₋₁₀alkyl and substituted C₁₋₁₀alkyl where the substituents are selected from the group consisting of halogen, hydroxyl, C₁₋₁₀alkoxycarbonyl, C₁₋₁₀alkoxy, cyano, amido, imido and silyl.

The alicyclic co-polymers consist of at least two different alicyclic polymer s. The preferred alicyclic co-polymers contain two or three different alicyclic polymer s, selected from the group consisting of

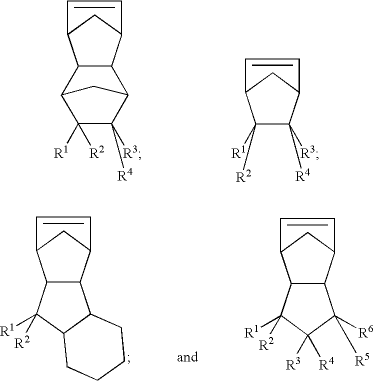

The particularly preferred alicyclic co-polymer contains two different alicyclic momoners where the generic structure of the saturated carbocyclic rings of the alicyclic polymers are of the formula

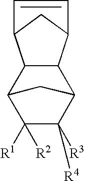

and R¹-R⁴ are C₁₋₁₀alkyl.

Typically the surface energy of the alicyclic co-polymer is between 28 and 45 dynes/cm at 25° C. A preferred alicyclic co-polymer contains two different alicyclic polymers and is sold by Zeon Chemicals L.P. under the trade name ZEONOR. There are several different grades of ZEONOR. Various grades may have glass transition temperatures ranging from 70° C. to 160° C. A specifically preferred material is ZEONOR 1060R, which according the to the manufacturer, ZEON Chemicals L.P. has an melt flow rate (“MFR”) range of 11.0 grams/10 minutes to 18.0 grams/10 minutes (as tested JISK 6719 (230° C.)), a specific gravity (H₂O=1) of 1.01 and a glass transition temperature of 100° C. Combining a TPR such as Zeonor 1060R with a TPE can result in a compound of TPR and TPE with a greater meltflow rate. Therefore, for example, a TPR with a meltflow rate of about 21 g/10 minutes combined with a TPE can have a meltflow of greater than about 21 g/10 minutes.

Other mold materials with which a TPE can be blended with to form an ophthalmic lens mold include, for example, Zieglar-Natta polypropylene resins (sometimes referred to as znPP). On exemplary Zieglar-Natta polypropylene resin is available under the name PP 9544 MED. PP 9544 MED is a clarified random copolymer for clean molding as per FDA regulation 21 CFR (c)3.2 made available by ExxonMobile Chemical Company. PP 9544 MED is a random copolymer (znPP) with ethylene group (hereinafter 9544 MED). Other exemplary Zieglar-Natta polypropylene resins include: Atofina Polypropylene 3761 and Atofina Polypropylene 3620WZ.

In some preferred methods of making molds 100 according to the present invention, injection molding is utilized according to known techniques, however, embodiments can also include molds fashioned by other techniques including, for example: lathing, diamond turning, or laser cutting.

Typically, lenses are formed on at least one surface of both mold parts 101-102. However, in some embodiments, one surface of the lenses may be formed from a mold part 101-102 and the other lens surface can be formed using a lathing method, or other methods.

As used herein “lens forming surface” means a surface 103-104 that is used to mold a lens. In some embodiments, any such surface 103-104 can have an optical quality surface finish, which indicates that it is sufficiently smooth and formed so that a lens surface fashioned by the polymerization of a lens forming material in contact with the molding surface is optically acceptable. Further, in some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof.

### Methods

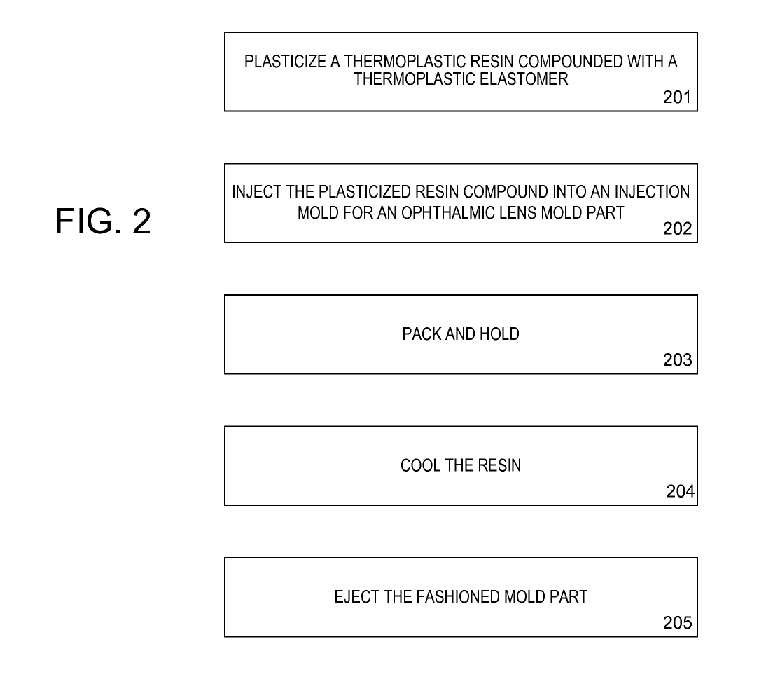

Referring now to FIG. 2, some embodiments of the present invention include methods of making an ophthalmic lens comprising, consisting essentially of, or consisting of the following described steps. At 201, a resin of including a TPR compounded with a TPE, such as for example SEBS, is plasticized and prepared for use in an injection molding process. Injection molding techniques are well known and typically involve heating resin pellets beyond a melting point.

At 202, the plasticized resin is injected into an injection mold shaped in a fashion suitable for creating an ophthalmic lens mold part 101-102. At 203, the injection mold is typically placed in a pack and hold status for an appropriate amount of time, which can depend, for example upon the resin utilized and the shape and size of the mold part. At 204, the formed mold part 101-102 is allowed to cool and at 205, the mold part 101-102 can be ejected, or otherwise removed from the injection mold.

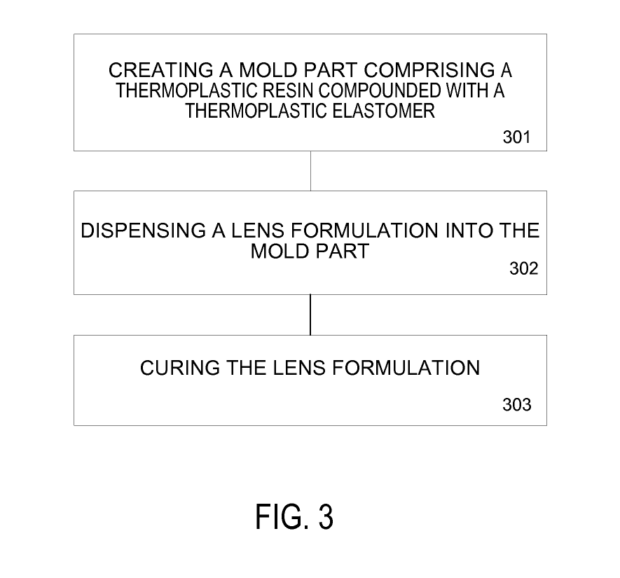

Referring now to FIG. 3, some embodiments of the present invention include methods of making an ophthalmic lens comprising, consisting essentially of, or consisting of the following steps. At 301 one or more mold parts 101-102 are created which comprise, consist essentially of, or consist of, including a TPR compounded with a TPE. At 302, an uncured lens formulation is dispensed onto the one or more mold parts 101-102 and at 303, the lens formulation is cured under suitable conditions. Additional steps can include, for example, hydrating a cured lens until it releases from a mold part 101-102 and leaching acute ocular discomfort agents from the lens.

As used herein, the term “uncured” refers to the physical state of a lens formulation prior to final curing of the lens formulation to make the lens. In some embodiments, lens formulations can contain mixtures of monomers which are cured only once. Other embodiments can include partially cured lens formulations that contain monomers, partially cured monomers, macromers and other components.

As used herein, the phrase “curing under suitable conditions” refers to any suitable method of curing lens formulations, such as using light, heat, and the appropriate catalysts to produce a cured lens. Light can include, in some specific examples, ultra violet light. Curing can include any exposure of the lens forming mixture to an actinic radiation sufficient to case the lens forming mixture to polymerize.

### Additives

Aside from the TPR AND TPE, the molds of the invention may contain additives that facilitate the separation of the lens forming surfaces, reduce the adhesion of the cured lens to the molding surface, or both.

In some embodiments, preferred additives can include polyvinyl pyrrolidinone, zinc stearate and glycerol mono stearate, where a weight percentage of additives based upon the total weight of the polymers is about 0.05 to about 10.0 weight percent, preferably about 0.05 to about 3.0, most preferably between about 1.0 to 2.0 weight percent.

### Surfactants

In addition to TPR and TPE blends, release of a formed lens from one or both lens forming surfaces 103-104 may be facilitated by applying surfactants to one or more of the lens forming surfaces 103-104. Examples of suitable surfactants can include Tween surfactants, particularly Tween 80.

### Comparative Mold Qualities

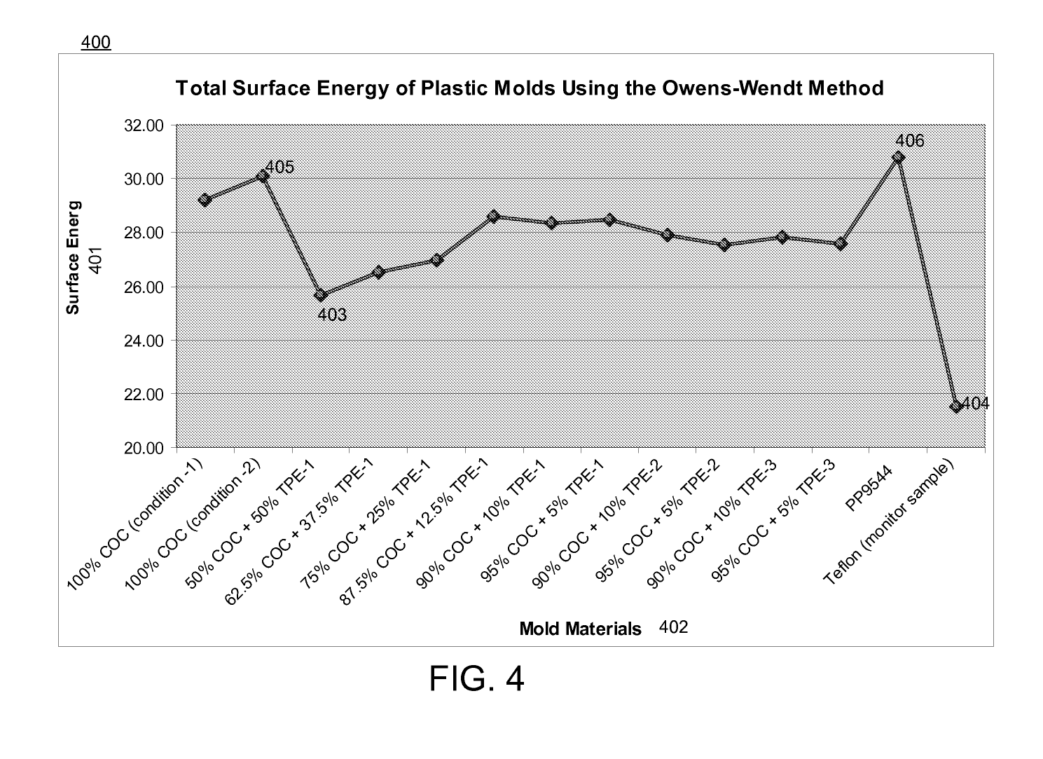

Referring now to FIG. 4, a chart 400 is provided which illustrates surface energy characteristics of mold materials, in including some molds fashioned from a compound including a TPR and a TPE. Data associated with the chart 400 is included herein as Table 1. As indicated on the chart 400 and in Table 1, exemplary TPEs used in the examples include: TUFTEC™ H1051, H1052 and 1062, which both all hydrogenated styrene/diene block TPEs and are manufactured by Asahi Kasei K.K.

The axis showing mold parts 402 includes mold parts made from Zeonor 1060R 403-404 and polypropylene 2 410, each tested without a TPE. Zeonor 1060R was additionally tested with various amounts of TPE. The Zeonor 1060R samples 403-404 without TPE demonstrated a surface energy greater that 28 mN/m using either the Zisman method for testing surface energy or the Owens-Wendt method. The polypropylene 2 sample 410 without TPE demonstrated a surface energy greater that 30 mN/m using either the Zisman method for testing surface energy or the Owens-Wendt method.

Compounded with TPE, the surface energy of Zeonor 1060R samples decreased significantly. A mold material of about 50% Zeonor 1060R and about 50% TPE (H1051) resulted in surface energy characteristics in the range of 25 mN/m.

TABLE 1

| | | Surface Energy (mN/m) using | | |
|---|---|---|---|---|
| | | Owens-Wendt Method | | |
| Sample ID | Surface Energy | Total Surface | Disperse Part | |
| Mold | (mN/m) using | Energy | Surface Energy | Polar Part Surface |
| Materials | Zisman Method | (mN/m) | (mN/m) | Energy (mN/m) |
| Zeonor 1060R | 28.1 | 29.18 | 28.74 | 0.44 |
| Zeonor 1060R | 28.64 | 30.1 | 29.55 | 0.55 |
| 95% Zeonor | 28.32 | 28.48 | 28.38 | 0.09 |
| 1060R + 5% | | | | |
| TPE 1 | | | | |
| 90% Zeonor | 27.98 | 28.32 | 28.24 | 0.07 |
| 1060R + 10% | | | | |
| TPE 1 | | | | |
| 82.5% Zeonor | 27.8 | 28.6 | 28.2 | 0.4 |
| 1060R + 12.5% | | | | |
| TPE 1 | | | | |
| 75% Zeonor | 26.4 | 26.97 | 26.89 | 0.07 |
| 1060R + 25% | | | | |
| TPE 1 | | | | |
| 62.5% Zeonor | 25.5 | 26.5 | 26.2 | 0.3 |
| 1060R + 37.5% | | | | |
| TPE 1 | | | | |
| 50% Zeonor | 25.2 | 25.66 | 25.64 | 0.02 |
| 1060R + 50% | | | | |
| TPE 1 | | | | |
| 95% Zeonor | 27.71 | 27.88 | 0.08 | 27.8 |
| 1060R + 10% | | | | |
| TPE 2 | | | | |
| 95% Zeonor | 27.51 | 27.51 | 27.46 | 0.05 |
| 1060R + 5% | | | | |
| TUFTEC TPE 2 | | | | |
| 90% Zeonor | 27.69 | 27.79 | 27.76 | 0.03 |
| 1060R + 10% | | | | |
| TPE 2 | | | | |
| 95% Zeonor | 27.78 | 27.57 | 27.57 | 0 |
| 1060R + 5% | | | | |
| TPE 3 | | | | |
| PP9544 | 31.04 | 30.77 | 30.72 | 0.05 |
| Teflon (Monitor | 18.33 | 21.51 | 21.5 | 0.05 |
| Sample) | | | | |

In addition to surface energy, contact angle measurements for mold parts fashioned from Zeonor 1060R were recorded. Those parts which included a TPE demonstrated a higher contact angle. Mold parts fashioned from about 50% Zeonor 1060R and about 50% Tuftec H1051 resulted in a contact angle of water of about 104.2, which is a significant increase over the parts fashioned without TPE.

| Sample ID | Contact Angle (°) | | | |
|---|---|---|---|---|
| Mold Materials | Water | Bromobenzene | Decalin | Formamide |
| Zeonor 1060R | 96.3 | 36.5 | 20.2 | 77.8 |
| Zeonor 1060R | 95.19 | 38.5 | 18.8 | 73 |
| 95% Zeonor 1060R + | 100.8 | 38.2 | 18.5 | 80.5 |
| 5% TUFTEC H1051 | | | | |
| 90% Zeonor 1060R + | 101.4 | | 20.5 | 80.4 |
| 10% TUFTEC H1051 | | | | |
| 82.5% Zeonor | 96.4 | 37 | 19.8 | 81.3 |
| 1060R + 12.5% | | | | |
| TUFTEC H1051 | | | | |
| 75% Zeonor 1060R + | 101.9 | 46.6 | 19.6 | 83.6 |
| 25% TUFTEC H1051 | | | | |
| 62.5% Zeonor | 98.6 | 45.6 | 23 | 85.1 |
| 1060R + 37.5% | | | | |
| TUFTEC H1051 | | | | |
| 50% Zeonor 1060R + | 104.2 | | 29 | 87 |
| 50% TUFTEC H1051 | | | | |
| 95% Zeonor 1060R + | 101.4 | | 21.3 | 81.6 |
| 10% TUFTEC H1052 | | | | |
| 95% Zeonor 1060R + | 102 | | 19.7 | 84.2 |
| 5% TUFTEC H1052 | | | | |
| 90% Zeonor 1060R + | 102.7 | | 21 | 82.9 |
| 10% TUFTEC H1062 | | | | |
| 95% Zeonor 1060R + | 104 | | 19.9 | 85.2 |
| 5% TUFTEC H1062 | | | | |
| PP 9544 | 104 | 26.4 | 7.2 | 85 |
| Teflon (Monitor | 112 | 53.5 | 51.5 | 94.9 |
| Sample) | | | | |

Reduced mold surface energy facilitates improved demold of lenses wherein during a demold process fewer lenses are damaged due to tears and pulls and additionally facilitates improved release from a mold part to which the lens remains adhered following demold. The lens is typically released through a process involving exposure of the lens and the mold part to an aqueous solution. The inclusion of an SEBS in a polyolefin mold material reduced an average lens release time by more than 60%. Lens release percentages of over 90% occurred with compound including between 5% and 50% TPE.

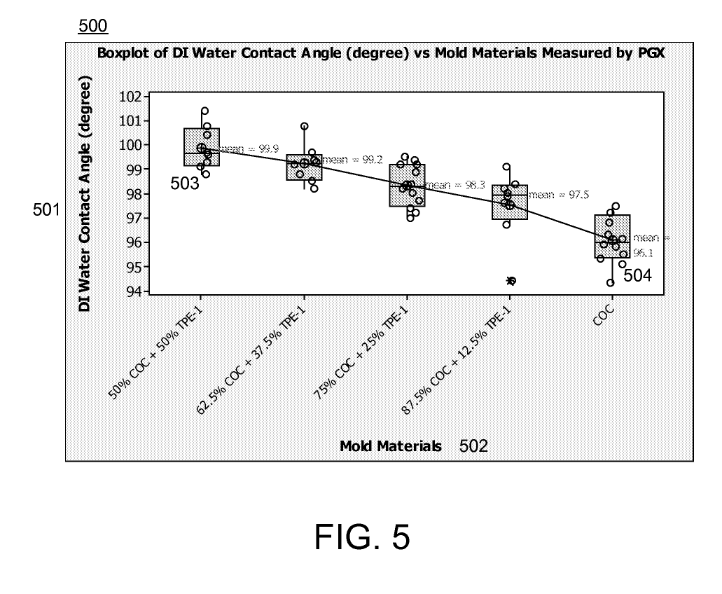

Referring now to FIG. 5, a box plot chart 500 illustrates the relationship between DI water contact angle 501 and mold materials 502 with various amounts of a TPE combined with a TPR of a cyclic olefin copolymer (“COC”). As indicated in the chart, according to the present invention, a direct relationship can be obtained between the contact angle of DI water 501 and an amount of TPE included in a mold compound up to a ratio of about 50% of TPE to COC. The box plot of 50% TPE to COC 503 indicates a contact angle of DI water of about 100 and includes the highest box plot value 503. The COC with 0% TPE indicates a box plot of about 96% and includes the lowest box plot value 504. As indicates, and according to the present invention, other ratio values fall in between these two.

In a related aspect of contact lens manufacture, lens yields related to demold were increased with the inclusion of SEBS in the mold parts 101-102. Lens yields were increased due to a decreased incidence of chips and tears in lenses and reduced surface markings on lenses.

In still another aspect, for high quality of mold parts 101-102 and maintaining fast cycle time of injection molding process, preferred blending ratios of TUFTEC™ H1051 (SEBS) with a polyolefin, such as Zeonor 1060R of about ≦50% weight; with some embodiments including ratios of TUFTEC™ H1051 (SEBS) with Zeonor 1060R of about ≦25% weight; and still others with blending ratios of TUFTEC™ H1051 (SEBS) and Zeonor1060R of about ≦12.5% weight.

TUFTEC™ H1051 is a trade name of Asahi Kaesi K.K. for SEBS (Styrene-ethylene-butadiene-styrene). SEBS, a special olefin and block copolymer, is a type of elastomer and in some embodiments includes an amorphous polymer. Generally, samples of TUFTEC™ H1051 utilized in the samples generating exemplary data herein contains ˜42% styrene unit and ˜58% ethylene-butadiene (EB) unit. There are two (2) glass transition temperatures (Tg) of TUFTEC™ H1051. The Tg of styrene unit (hard segment) is 96° C. and the Tg of EB unit (soft segment) is −43° C. SEBS block copolymer is currently a commercially available TPE.

In other embodiments, the thermoplastic elastomer can include a styrene block which includes, by way of non-limiting example: a styrene-butadiene block copolymer (SBS), styrene-isoprene-styrene block copolymer (SIS), styrene-isoprene-butadiene-styrene block copolymer (SIBS), or hydrogenated copolymer of respective copolymers. In other words, a thermoplastic elastomer containing the styrene block can be an SBS, hydrogenated SBS, SIS, hydrogenated SIS, SIBS, or hydrogenated SIBS. As the hydrogenated SBS, for example, a styrene-ethylene-butylene-styrene block copolymer (SEBS) can be used. As the hydrogenated SIS, for example, a styrene-ethylene-propylene-styrene block copolymer (SEPS) can be used. As the hydrogenated SIBS, for example, a styrene-ethylene-ethylene-propylene-styrene block copolymer (SEEPS) can be used. As the hydrogenated SEP, for example, a styrene-ethylene-propylene block copolymer may be used.

The thermoplastic elastomer containing the styrene block (Component C) can be a styrene-butadiene-styrene block copolymer (SBS), hydrogenated SBS, styrene-isoprene-styrene block copolymer (SIS), hydrogenated SIS, styrene-isoprene-butadiene-styrene block copolymer (SIBS), hydrogenated SIBS, or a polymer alloy formed of a polyolefin. Here, the polymer alloy is either a blend of a block copolymer such as SBS and the like described above a polyolefin, or a polymer including the block copolymer as described above and the polyolefin as constituents of the polymer chain.

Preferably, the thermoplastic elastomer containing the styrene block can have a shore A hardness of about 95 or less and in some embodiments 60 or less. Preferable test methods for determining shore A hardness include: test method of JIS K6253 and ISO 48.

### CONCLUSION

The present invention, as described above and as further defined by the claims below, provides mold parts 101-102 fashioned from a thermal plastic resin compounded with a thermal plastic elastomer.

What is claimed is:

1. An improved method of molding an ophthalmic lens, wherein a lens forming mixture is cured in a cavity of a desired shape formed by two or more mold parts;
the improvement comprising at least one of the mold parts comprising a thermal plastic resin compounded with a thermal plastic elastomer.

2. The method of claim 1, wherein a first mold part comprises a concave surface, a second mold part comprises a convex surface, and at least the second mold part comprises a thermal plastic resin compounded with a thermal plastic elastomer.

3. The method of claim 1, wherein a first mold part comprises a concave surface and a second mold part comprises a convex surface and both the first mold part and the second mold part comprise a thermal plastic resin compounded with a thermal plastic elastomer.

4. The method of claim 1 wherein at least one of the mold parts is transparent to polymerization initiating radiation and the cavity comprises the shape and size of an ophthalmic lens, the method additionally comprising the steps of:
depositing lens forming mixture comprising a polymerizable composition in the cavity; and
exposing the mold parts and the polymerizable composition to polymerization initiating radiation.

5. The method of claim 1, wherein at least one mold part molded from a thermal plastic resin compounded with a thermal plastic elastomer comprises a surface energy of less than 30 mN/m as determined with one or ore of: the Owens-Wendt method and the Zisman method.

6. The method of claim 1, wherein at least one mold part molded from a thermal plastic resin compounded with a thermal plastic elastomer comprises a surface energy of less than 26 mN/m as determined with one or more of: the Owens-Wendt method and the Zisman method.

7. The method of claim 3 wherein at least one mold part molded from a thermal plastic resin compounded with a thermal plastic elastomer comprises a contact angle of deionized water greater than about 99°.

8. A mold assembly for forming an ophthalmic lens, the mold assembly comprising:
a first mold part and a second mold part positioned relative to each other to form a cavity in a shape and size suitable to form an ophthalmic lens;
at least one of the first mold part and the second mold part comprising a lens forming surface; and
wherein at least one of the first mold part and the second mold part comprises a thermal plastic resin compounded with a thermal plastic elastomer.

9. The mold of claim 8 wherein the thermal plastic elastomer comprises styrene block copolymer.

10. The mold of claim 9 wherein the thermal plastic elastomer comprises one or more of the group comprising: styrene ethylene butylene; styrene ethylene propylene; and a styrene-ethylene-ethylene-propylene-styrene block copolymer.

11. The mold of claim 8 wherein the at least one of the first mold part and the second mold part comprising a thermal plastic resin compounded with a thermal plastic elastomer, comprises between about 5% weight and 75% weight thermal plastic elastomer.

12. The mold of claim 8 wherein the at least one of the first mold part and the second mold part comprising a thermal plastic resin compounded with a thermal plastic elastomer, comprises between about 10% weight and 50% weight thermal plastic elastomer.

13. The mold of claim 8 wherein the thermoplastic resin comprises an alicyclic polymer.

14. The mold of claim 8 wherein the thermoplastic resin comprises a polyolefin having a melt flow rate of less than 21 g/10 minutes and the thermal plastic resin compounded with a thermal plastic elastomer has a melt flow rate greater than about 21 g/10 minutes.

15. An ophthalmic lens produced by a method comprising the steps of:
dispensing an uncured lens formulation onto a surface of a mold part formed from a resin comprising a thermal plastic resin compounded with a thermal plastic elastomer; and
curing said lens formulation under actinic conditions suitable to the uncured lens formulation.

16. The ophthalmic lens of claim 15 wherein the uncured lens formulation comprises a silicone hydrogel formulation.

17. The lens of claim 15 wherein the uncured lens formulation comprises a hydrogel formulation.

18. The lens of claim 15 wherein the uncured lens formulation comprises at least one of: acquafilcon A, balafilcon A, and lotrafilcon A.

19. The lens of claim 11 wherein the uncured lens formulation comprises at least one of: etafilcon A, genfilcon A, lenefilcon A, polymacon and galyfilcon A, and senofilcon A.

20. The lens of claim 11 wherein the uncured lens formulation comprises senofilcon A.
